(19) United States
(12) Patent Application Publication
(10) Pub. No.: US 2010/0078216 A1
(43) Pub. Date: Apr. 1, 2010

(54) DOWNHOLE VIBRATION MONITORING FOR REAMING TOOLS

(75) Inventors: Steven R. RADFORD, The Woodlands, TX (US); Leslie T. SHALE, Willis, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: BAKER HUGHES INCORPORATED, Houston, TX (US)

(21) Appl. No.: 12/237,563

(22) Filed: Sep. 25, 2008

(51) Int. Cl. G06F 17/00; E21B 47/00; E21B 47/18

(52) U.S. Cl. 175/40

(57) ABSTRACT

The present invention relates to methods and systems for optimizing the design of a bottomhole assembly, a reamer tool or other component of the bottomhole assembly, and/or drilling parameters of the bottomhole assembly. The method may include placing electronic modules in pockets of or adjacent to the reamer tool; reaming a borehole with the reamer tool while the modules record and store data for later retrieval; and then retrieving the data from the modules to optimize the design of the reamer tool. The modules may record vibration along three axis. The reamer tool may be a concentric reamer, an eccentric reamer, or virtually any type of reamer known in the art. In some embodiments, the bottomhole assembly may utilize a roller cone or drag bit below the reamer tool as a pilot bit.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to bottomhole assemblies; and more specifically relate to methods and systems for the design and optimization of reamer tools and/or other components used in bottomhole assemblies.

2. Description of the Related Art

U.S. Pat. No. 4,661,932 discloses a “method and apparatus allows dynamic data to be recorded in a drill string for later playback at the surface. The system includes a transducer located in a sub in the drill string which provides electrical responses to a analog to digital converter. A timer circuit provides timer pulses to the converter to cause the response to be converted into a digital value for storing in a recorder. The timer pulses are also used to address the memory location. The timer circuit has the ability to provide a variable number of timer pulses at a variable frequency and at variable intervals. A surface timer circuit provides simultaneous timer pulses to a counter to indicate at the surface which memory location is being filled at any given time.”

U.S. Pat. No. 4,695,957 discloses “a drilling monitor downhole transducers [that] provide signals representative of torque (T) and axial load (F). A downhole computer apparatus (5) receives the torque and load signals and computes coefficients representative of drilling conditions. These coefficients may then be combined into a surface sendable signal indicative of drilling conditions. Signals representing T and F are received from downhole transducers (1,2) at input ports (3,4) of the downhole computer (5). From T and F measurements a relationship between T and F may be established, based on short term modeling. From the system model, torque may be predicted and correlated with the measured values received from the torque transducer (1). Values from the coefficients are computed and combined for sending from a transmitter (6) to a receiver (7) over a single low speed telemetry channel (8) for display and recording at the surface.”

U.S. Pat. No. 4,811,597 discloses a “drill string sub . . . for measuring the torque and axial compression in the drill string. The drill string sub includes an outer tubular housing and an inner sleeve type apparatus mounted thereto for amplifying the strain the sensors measure. The sub further includes a section for compensating for the axial stresses due to the local pressure differential between the drill string bore and the well bore annulus and for the thermal gradients occurring during operation. This section includes a balance tube for isolating the internal bore pressure from acting on the strain amplifier and for creating an upward axial force on the tubular housing and strain amplifier which is responsive to this pressure differential to counter the axial stresses mentioned above. The sensors are encapsulated in oil to avoid the effects of the corrosion and electrical shorting which are promoted by drilling fluids.”

U.S. Pat. No. 4,854,403 discloses a “stabilizer for deep well drilling tools . . . which includes a tubular outer casing having a plurality of slit openings distributed around its periphery with a tubular adjusting mandrel supported in the casing for relative axial movement therewith in response to well fluid pressure applied to the well. A separate elongated ribbed body is movably mounted in each slit opening. Each of the ribbed bodies has a rear wedge face facing opposite to the relative motion of the mandrel which cooperates with a separate mating wedge face on the mandrel such that the ribbed body moves radially outwardly in its respective slit opening upon contact between said mating wedges upon axial movement of the mandrel relative to the casing in response to well fluid pressure applied to the well. Also, each end of each ribbed body has an axially projecting guide projection which terminates in a reduced dimension at its end. Each guide projection has a separate securing piece adapted to be inserted through a slit from outside the casing to hold its guide projection in the casing. Each securing piece has the basic shape of a cylindrical segment and can be inserted into the casing so it is flush therewith. A separate locking pin secures each securing piece in the casing.”

U.S. Pat. No. 5,138,875 discloses “a method of monitoring the drilling of a borehole through an earth formation with a rotating drill bit fixed at the lower end of a drillstring. At least one physical quantity associated with the vibrations resulting from the interaction of the rotating drill bit with the earth formation is detected and an oscillatory signal is generated in response thereto. Filter coefficients a.sub.k of an auto-regressive filter model are determined by fitting the filter output signal with the oscillatory signal. The reflection coefficients of the vibrations propagating along the drill string and being reflected by a mis-match of impedance of two successive elements of the system earth formation/drillstring are derived from the filter coefficients. Finally, the hardness of the formation being drilled, the contact of the drillstring with the borehole and the vibration level of the vibration along the drillstring are determined from the reflection coefficients.”

U.S. Pat. No. 5,226,332 discloses a “vibration monitoring system [that] operates down-hole in the bottom hole assembly above the drill bit. This system includes four spaced accelerometers which measure and differentiate between lateral, longitudinal and torsional drillstring vibrations. Three of the four accelerometers are in a cooperative spaced arrangement and measure tangential acceleration forces on the outer diameter of the drillstring for determining and measuring both lateral and torsional vibrations. The fourth accelerometer measures longitudinal vibration. Two embodiments are disclosed for arranging the three accelerometers which measure lateral and torsional vibration. In a first embodiment, the accelerometers are equi-spaced 120 degrees apart from one another. In a second embodiment, the three accelerometers are spaced 30 degrees apart from one another within a 60 degree arc. In both embodiments, all four accelerometers are positioned within the annular wall of a drill collar segment.”

U.S. Pat. No. 5,497,842 discloses a “reaming apparatus for enlarging a borehole, including a tubular body having one or more longitudinally and generally radially extending blades circumferentially spaced thereabout. Each of the blades carries highly exposed cutting elements, on the order of fifty percent exposure, on its profile substantially all the way to the gage. At least one of the blades is a primary blade for cutting the full or drill diameter of the borehole, while one or more others of the blades may be secondary blades which extend a lesser radial distance from the body than the primary blade. A secondary blade initially shares a large portion of the cutting load with the primary blade while the borehole size is in transition between a smaller, pass through diameter and drill diameter. It functions to enhance the rapidity of the transition while balancing side reaction forces, and reduces vibration and borehole eccentricity. After drill diameter is reached, cutting elements on the secondary blade continue to share the cutting load over the radial distance they extend from the body.”

U.S. Pat. No. 5,765,653 discloses a “method and apparatus for reaming or enlarging a borehole with enhanced stability. A pilot stabilization pad (PSP) having an axially and circumferentially tapered entry surface and a circumferential transition surface above is employed to enhance the transition from the smaller diameter borehole to be enlarged while accommodated the side force vector generated by the cutting assembly used to effect the enlargement. In addition, one or more eccentric stabilizers are employed above the reaming apparatus to laterally or radially stabilize the bottomhole assembly, which may comprise either a straight-hole or steerable, motor-driven assembly.”

U.S. Pat. No. 5,813,480 discloses “an improved method and apparatus for monitoring and recording of operating conditions of a downhole drill bit during drilling operations. The invention may be alternatively characterized as either (1) an improved downhole drill bit, or (2) a method of monitoring at least one operating condition of a downhole drill bit during drilling operations in a wellbore, or (3) a method of manufacturing an improved downhole drill bit. When characterized as an improved downhole drill bit, the present invention includes (1) an assembly including at least one bit body, (2) a coupling member formed at an upper portion of the assembly, (3) at least one operating conditioning sensor carried by the improved downhole drill bit for monitoring at least one operating condition during drilling operations, and (4) at least one memory means, located in and carried by the drill bit body, for recording in memory data pertaining to the at least one operating condition. Optionally, the improved downhole drill bit of the present invention may cooperate with a communication system for communicating information away from the improved downhole drill bit during drilling operations, preferably ultimately to a surface location. The improved downhole drill bit of the present invention may further include a processor member, which is located in and carried by the drill bit body, for performing at least one predefined analysis of the data pertaining to the at least one operating condition, which has been recorded by the at least one memory means.”

U.S. Pat. No. 5,864,058 discloses a “downhole sensor sub [that] is provided in the lower end of a drillstring, such sub having three orthogonally positioned accelerometers for measuring vibration of a drilling component such as the drill bit and/or the bottom hole assembly (BHA) along the X, Y and Z axes. The lateral acceleration is measured along either the X or Y axis and then analyzed in the frequency domain as to peak frequency and magnitude at such peak frequency. Backward whirling of the drilling component is indicated when the magnitude at the peak frequency exceeds a predetermined value. A low whirling frequency accompanied by a high acceleration magnitude based on empirically established values is associated with destructive vibration of the drilling component. One or more drilling parameters (weight on bit, rotary speed, etc.) is then altered to reduce or eliminate such destructive vibration.”

U.S. Pat. No. 6,196,335 discloses a “downhole tool for use at or near the bit measures the vibrations at or near the bit. The tool uses statistical techniques to choose strong events. The tool sends data regarding the strong events to the surface via telemetry.”

U.S. Pat. No. 6,216,533 discloses a “downhole drilling efficiency sensor (DES) apparatus for use with drilling operations in oil and gas exploration, that accurately measures important drilling parameters at or near the drill bit in order to increase the effectiveness and productivity of the drilling operation. The parameters measured include weight-on-bit (WOB), torque-on-bit (TOB), bending-on-bit (BOB), annulus pressure, internal bore pressure, triaxial vibration (DDS—drilling dynamics sensor), annulus temperature, load cell temperature, and drill collar inside diameter temperature or thermal gradient across such drill collar. The direction of the bending-on-bit measurement is also determined with respect to the low side of the hole while rotating (or stationary) by using a triaxial vibration sensor and magnetometer array. Each of the parameters are known to be important factors in determining the direction, rotation, and rate of drilling. The device described combines sensors capable of collecting all of the indicated parameters and presenting them to the drilling operator such that an accurate view of the downhole drilling parameters can be obtained.”

U.S. Pat. No. 6,230,822 discloses a “drill bit for use in drilling operations in a wellbore, the drill bit having a bit body including a plurality of bit legs, each supporting a rolling cone cutter; a coupling member formed at an upper portion of said bit body; at least one temperature sensor for monitoring at least one temperature condition of said improved drill bit during drilling operations; and at least one temperature sensor cavity formed in said bit body and adapted for receiving, carrying, and locating said at least one temperature sensor in a particular position relative to said bit body which is empirically determined to optimize temperature sensor discrimination.”

U.S. Pat. No. 6,419,032 discloses an “improved drill bit [that] includes a condition sensor and a semiconductor memory. The condition sensor includes an electrical sensor which has an attribute which changes in response to changes in the bit condition. Monitoring and sampling circuits are utilized to record this data into the semiconductor memory. A communication system may be provided which includes a signal flow path and a selectively-actuable flow control device for controlling the signal flow path until a predetermined operating condition is detected; upon actuation, a detectable pressure change is developed in the wellbore.”

U.S. Pat. No. 6,510,906 discloses a “drill bit employing a plurality of discrete, post-like diamond grit impregnated cutting structures extending upwardly from abrasive particulate-impregnated blades defining a plurality of fluid passages therebetween on the bit face. PDC cutters with faces oriented in the general direction of bit rotation are placed in the cone of the bit, which is relatively shallow, to promote enhanced drilling efficiency through softer, non-abrasive formations. A plurality of ports, configured to receive nozzles therein are employed for improved drilling fluid flow and distribution. The blades may extend radially in a linear fashion, or be curved and spiral outwardly to the gage to provide increased blade length and enhanced cutting structure redundancy.”

U.S. Pat. No. 6,540,033 discloses an “improved drill bit [that] is provided with a sensor for monitoring an operating condition during drilling. A fastener system is provided for securing an erodible ball in a fixed position relative to a flow pathway until a predetermined operating condition is detected by the sensor, and for releasing the erodible ball into the flow pathway to obstruct the flow through at least one bit nozzle.”

U.S. Pat. No. 6,543,312 discloses a “drill bit for use in drilling operations in a wellbore, the drill bit having a bit body including a plurality of bit legs, each supporting a rolling cone cutter; a coupling member formed at an upper portion of the bit body; at least one temperature sensor for monitoring at least one temperature condition of the improved drill bit during drilling operations; and at least one temperature sensor cavity formed in the bit body and adapted for receiving, carrying, and locating the at least one temperature sensor in a particular position relative to the bit body which is empirically determined to optimize temperature sensor discrimination.”

U.S. Pat. No. 6,571,886 discloses an “improved drill bit [that] includes a bit body, a coupling member formed at an upper shank portion. It further includes at least one sensor for monitoring at least one condition of the bit during drilling operations. In one embodiment the at least one sensor is a capacitor disposed in a lubrication pathway. An electronics bay is defined in-part by the upper shank portion. It houses at least one monitoring circuit. A battery cavity is disposed in at least one of the bit legs. A battery cavity cap is provided. A seal is provided to seal the battery cavity cap at the bit leg to define a fluid tight battery cavity.”

U.S. Pat. No. 6,626,251 discloses an “improved drill bit [that] is provided with a sensor for monitoring an operating condition during drilling. A fastener system is provided for securing an erodible ball in a fixed position relative to a flow pathway until a predetermined operating condition is detected by the sensor, and for releasing the erodible ball into the flow pathway to obstruct the flow through at least one bit nozzle.”

U.S. Pat. No. 6,648,082 discloses an “apparatus and accompanying method for monitoring and reporting downhole bit failure. Individual sensors are placed on a sub which is separate from the drill bit itself, and are powered by a vibration driven power system. The sensor readings are used to compute values which represent the ratios of sensor readings on one sensor in relation to the readings of one or more other sensors. This creates a self-calibrating sensor system that accounts for changes in downhole conditions which might cause sensor readings to fluctuate, but which do not indicate failure.”

U.S. Pat. No. 6,675,101 discloses a “method for supplying a customer with well log data including obtaining wellsite properties from the customer, recommending at least one tool string and analysis software tool combination using the wellsite properties, processing well log data using customer domain information and the least one tool string and analysis software tool combination to obtain processed well log data, viewing the processed well log data using an interactive viewer, manipulating the customer domain information, and updating the processed well log data on the interactive viewer using the manipulated customer domain information.”

U.S. Pat. No. 6,681,633 discloses an “apparatus and method for monitoring and reporting downhole bit failure. Sensors are located on a sub assembly (which is separate from the drill bit itself but located above it on the drill string). Data from the sensors (preferably accelerometers) are collected in blocks, then analyzed in the frequency domain. The frequency domain is divided into multiple bands, and the signal power in each band is compared to that of another band to produce a ratio of powers. When a bit is operating at normal condition, most of the spectral energy of the bit vibration is found in the lowest frequency band. As a bearing starts to fail, it produces a greater level of vibration in the higher frequency bands. This change in ratios is used to determine probable bit failure. Bit failure can be indicated by a given ratio surpassing a given threshold, or by monitoring the standard deviation of the frequency ratios. When the standard deviation exceeds a certain value, a failure is indicated.”

U.S. Pat. No. 6,691,802 discloses a “drill string [that] is equipped with a downhole assembly having an instrumented sub and a drill bit. The instrumented sub has a power source that requires no electrical chemical batter. A mass-spring system is used, which during drilling causes a magnet to oscillate past a coil. This induces current which is used to power downhole instruments.”

U.S. Pat. No. 6,695,073 discloses a “fixed-cutter drill bit [that] is optimized so that cutter torques are evenly distributed not only during drilling of homogeneous rock, but also in transitional formations.”

U.S. Pat. No. 6,695,080 discloses a “method and apparatus for reaming or enlarging a borehole with the ability to drill cement, cement float equipment, and debris out of a casing without substantial damage to the casing interior or the reaming apparatus. The reaming apparatus also provides enhanced protection from contact with the casing wall for selected structural features and elements thereof.”

U.S. Pat. No. 6,698,536 discloses a “roller cone drill bit . . . which includes at least one roller cone rotatably mounted to a bit body. The bit body includes therein a lubricant reservoir adapted to supply lubricant to bearings on which the roller cone rotates about the bit body. The bit includes a sensor adapted to detect drilling fluid contamination of the lubricant. The bit includes a processor/transmitter operatively coupled to the sensor and adapted to communicate signals corresponding to detected contamination.”

U.S. Pat. No. 6,722,450 discloses an “apparatus and method for monitoring and reporting downhole bit failure. Sensors are located on a sub assembly (which is removable from the drill bit) and send data to neural net or other adaptive filter. The neural net uses past sensor readings to predict future sensor readings. The value predicted for the sensors is subtracted from the actual value to produce a prediction error. Increases in prediction error are used to indicate bit failure. The results of this are transmitted to the operator by varying the pressure in the drilling mud flow.”

U.S. Pat. No. 6,739,416 discloses “[e]nhanced stabilization . . . for an eccentric reaming tool when a pilot borehole is undersized with respect to a following pilot stabilization pad (PSP). Alternatively, offset of a rotational axis of at least a portion of the assembly including the reaming tool is employed to accomplish stabilization of the reaming tool. In either case, a reamed diameter larger than a physical diameter of the reaming tool may be drilled. More specifically, an enlarged PSP relative to pilot bit diameter or PSP offset or even pilot bit offset is employed in order to engage a PSP with the wall of a pilot borehole of greater diameter than a physical diameter of the pilot bit. The PSP or pilot drill bit, or both, may be laterally offset, angularly offset, or a combination thereof in order to effect substantially continuous PSP contact with the pilot borehole wall.”

U.S. Pat. No. 6,766,254 discloses a “method and system for real time updating of an earth model. The efficiency with which an oil or gas well is constructed can be enhanced by updating the relevant earth model using real-time measurements of the effective density of the drilling fluid and other parameters. The method includes generating an earth model used for predicting potential problems in drilling of a borehole having a predetermined trajectory. Evaluations of the state of the borehole and local geological features are obtained which are based on the earth model. Real time data is used to create a diagnosis of the state of the borehole and local geological features. The evaluations are compared with a diagnosis to identify inconsistencies. A component of the earth model is identified that is both related to the identified inconsistency and has a high degree of uncertainty. The selected component of the earth model is then updated prior to completing construction of the borehole using the received data.”

U.S. Pat. No. 6,792,360 discloses “[s]ystems and methods for identifying the presence of a defect in vibrating machinery. An exemplary method comprises analysis of frequency spectrum vibration data of the machine. The method comprises deriving a harmonic activity index based on estimates of the energy associated with the frequency spectrum and the energy associated with the defect's harmonic series. The method may comprise deriving a value K by estimating a value M indicative of the energy of the defect's harmonic series and dividing M by the number of spectral lines corresponding to the defect's harmonic series. The method may further comprise deriving a value R by estimating a value Q indicative of the energy in the frequency spectrum data and dividing Q by the number of spectral lines of the frequency spectrum data. The method further comprises deriving the harmonic activity index based on the estimated K and R. Related systems for executing the methods are also disclosed.”

U.S. Pat. No. 6,814,162 discloses a “drill bit, comprising a bit body, a sensor disposed in the bit body, a single journal removably mounted to the bit body, and a roller cone rotatably mounted to the single journal.”

U.S. Pat. No. 6,817,425 discloses an “apparatus and method for monitoring and reporting downhole bit failure. Sensors are located on a sub assembly (which is separate from the drill bit itself but located above it on the drill string). Strain measurements are taken from the sensors to detect changes in induced bending and axial stresses which are related to a roller cone bearing failure. As a cone begins to fail, the average share of the total load on the bit that the failing cone can support changes, which causes a change in the bending strain induced by the eccentric loading of the cone.”

U.S. Pat. No. 6,850,068 discloses a “method and apparatus for obtaining a resistivity measurement of an earth formation surrounding a borehole in an MWD device uses an electrode for injecting current into the earth formation and an electrode for obtaining a responsive signal from the borehole. The electrodes are located on the drill bit arm or blade. Measured resistivity values are obtained at the location of the drill bit. Measurements can be taken in both oil-based mud and water-based mud environments. Maximum or minimum resistivity can be used to best represent the resistivity of the surrounding formation.”

U.S. Pat. No. 6,870,356 discloses a “method of mapping voltage potential along a metal structural member extending underground through a range of depths comprises the steps of providing a voltage meter having positive and negative terminals, a reference electrode connected to the positive terminal, and a half-cell connected to the negative terminal; forming at least one hole in the ground alongside the structural member; contacting the reference electrode with the structural member at an aboveground location; and positioning the half-cell at a series of test points in the hole(s) and taking a series of voltage potential measurements respectively corresponding to the series of test points, wherein the test points are located at different depths. Preferably, the method further comprises the step of plotting test point depth versus voltage potential. A novel drill bit for drilling the hole through earth comprises a common wood-boring auger shank and a flat masonry-style drill bit tip.”

U.S. Pat. No. 6,879,947 discloses a “drill bit is designed to achieve optimum performance in a specified drilling application defined by the drilling system, the formation to be drilled and the configuration of the bore hole. A depth of cut versus predicted torque for a basic bit configuration is evaluated for different configurations of the drill bit. A computer modeling program is used to obtain the predicted torque for the basic bit configuration, and its modifications. Features of the bit design are changed to achieve the lowest predicted torque for an optimum depth of cut. Presenting the computer analysis as depth of cut versus predicted torque for the bit design simplifies the design selection process. The formation being drilled may be evaluated by comparing actual torque with predicted torque for a given rate of penetration. The evaluation can be used to conform the computer model and determine formation properties.

U.S. Pat. No. 6,885,942 discloses a “method for detecting and visualizing changes in a borehole, comprising correlating a time-depth file and a time-data file to obtain a plurality of measurements at a specific depth for a parameter, analyzing a parameter change using at least two of the plurality of the measurements to obtain an interpretation of the parameter change, and displaying the interpretation of the parameter change using a graphical representation.”

U.S. Pat. No. 6,907,375 discloses “a method and apparatus for remotely analyzing and affirmatively notifying appropriate personnel of problems and events associated with an oil recovery system—comprising hundreds of oil rigs over a vast geographic area. The results of selected Health Checks, which are run on each oilrig, are reported to a central server. The central server populates a data base for the oil recovery system, displays a red/yellow/green color coded electronic notification and status for an entire oil recovery system and affirmatively alerts appropriate personnel of actions required to address events associated with an oilrig in an oil recovery system. The diagnostics run at each oilrig are configurable at the individual rig. The present invention provides a dynamic oilrig status reporting protocol that enables population and display of a tree node structure representing an entire oil recovery system status on a single screen at a top level. Detailed information is available by drilling down in to other screens, enabling rapid visual evaluation of a system Health Check.”

U.S. Pat. No. 6,968,909 discloses a system “for controlling borehole operations using a computational drilling process model representing the combined effect of downhole conditions and the operation of a drillstring. The drilling process model is continually updated with downhole measurements made during a drilling operation. From the updated drilling process model, a set of optimum drilling parameters is determined and communicated to a surface equipment control system. Further, the system allows the surface equipment control system to automatically adjust current surface equipment control settings based on the updated optimum drilling parameters. Various control scripts are generated and executed to inform the surface equipment control system based on a present drilling mode.”

U.S. Pat. No. 7,020,597 discloses a “method for improving drilling performance of a drilling tool assembly is disclosed. The method includes identifying a drilling performance parameter to be improved. One or more potential solutions are defined to improve the drilling performance parameter. A drilling simulation is performed to determine the dynamic response of the drilling tool assembly during a drilling operation. Determining the dynamic response includes determining the interaction of a cutting element of a drill bit with an earth formation. Improvement in the drilling performance parameter is determined based upon the drilling simulation.”

U.S. Pat. No. 7,032,689 discloses a “method and apparatus for predicting the performance of a drilling system for the drilling of a well bore in a given formation includes generating a geology characteristic of the formation per unit depth according to a prescribed geology model, obtaining specifications of proposed drilling equipment for use in the drilling of the well bore, and predicting a drilling mechanics in response to the specifications as a function of the geology characteristic per unit depth according to a prescribed drilling mechanics model. Responsive to a predicted-drilling mechanics, a controller controls a parameter in the drilling of the well bore. The geology characteristic includes at least rock strength. The specifications include at least a bit specification of a recommended drill bit. Lastly, the predicted drilling mechanics include at least one of bit wear, mechanical efficiency, power, and operating parameters. A display is provided for generating a display of the geology characteristic and predicted drilling mechanics per unit depth, including either a display monitor or a printer.”

U.S. Pat. No. 7,035,778 discloses a “method of assaying work of an earth boring bit of a given size and design including establishing characteristics of the bit of given size and design. The method further includes simulating a drilling of a hole in a given formation as a function of the characteristics of the bit of given size and design and at least one rock strength of the formation. The method further includes outputting a performance characteristic of the bit, the performance characteristic including a bit wear condition and a bit mechanical efficiency determined as a function of the simulated drilling.”

U.S. Pat. No. 7,036,611 discloses an “expandable reamer apparatus and methods for reaming a borehole, wherein a laterally movable blade carried by a tubular body may be selectively positioned at an inward position and an expanded position. The laterally movable blade, held inwardly by blade-biasing elements, may be forced outwardly by drilling fluid selectively allowed to communicate therewith by way of an actuation sleeve disposed within the tubular body. Alternatively, a separation element may transmit force or pressure from the drilling fluid to the movable blade. Further, a chamber in communication with the movable blade may be pressurized by way of a downhole turbine or pump. A ridged seal wiper, compensator, movable bearing pad, fixed bearing pad preceding the movable blade, or an adjustable spacer element to alter expanded blade position may be included within the expandable reamer. In addition, a drilling fluid pressure response indicating an operational characteristic of the expandable reamer may be generated.”

U.S. Pat. No. 7,054,750 discloses “[m]ethods and systems for controlling the drilling of a borehole . . . . The methods employ the assumption that nonlinear problems can be modeled using linear equations for a local region. Common filters can be used to determine the coefficients for the linear equation. Results from the calculations can be used to modify the drilling path for the borehole. Although the calculation/modification process can be done continuously, it is better to perform the process at discrete intervals along the borehole in order to maximize drilling efficiency.”

U.S. Pat. No. 7,066,280 discloses an “improved drill bit for use in drilling operations in a wellbore comprising a bit body including a plurality of bit legs, each supporting a rolling cone cutter, a lubrication system for a rolling cone cutter, at least one lubrication sensor for monitoring at least one condition of said lubricant during drilling operations, and an electronics member in the bit body for recording data obtained form said lubrication sensor.”

U.S. Pat. No. 7,083,006 discloses an “MWD method and apparatus for determining parameters of interest in a formation has a sensor assembly mounted on a slidable sleeve slidably coupled to a longitudinal member, such as a section of drill pipe. When the sensor assembly is held in a non-rotating position, for instance for obtaining the measurements, the longitudinal member is free to rotate and continue drilling the borehole, wherein downhole measurements can be obtained with substantially no sensor movement or vibration. This is particularly useful in making NMR measurements due to their susceptibility to errors due caused by tool vibration. In addition, the substantially non-rotating arrangement of sensors makes it possible to efficiently carry out VSPs, reverse VSPs and looking ahead of the drill bit. A clamping device is used, for instance, to hold the sensor assembly is held in the non-rotating position. The sensor assembly of the present invention can include any of a variety of sensors and/or transmitters for determining a plurality of parameters of interest including, for example, nuclear magnetic resonance measurements.”

U.S. Pat. No. 7,085,696 discloses an “iterative drilling simulation method and system for enhanced economic decision making includes obtaining characteristics of a rock column in a formation to be drilled, specifying characteristics of at least one drilling rig system; and iteratively simulating the drilling of a well bore in the formation. The method and system further produce an economic evaluation factor for each iteration of drilling simulation. Each iteration of drilling simulation is a function of the rock column and the characteristics of the at least one drilling rig system according to a prescribed drilling simulation model.”

U.S. Pat. No. 7,114,579 discloses a “method is disclosed for identifying potential drilling hazards in a wellbore, including measuring a drilling parameter, correlating the parameter to depth in the wellbore at which selected components of a drill string pass, determining changes in the parameter each time the selected components pass selected depths in the wellbore, and generating a warning signal in response to the determined changes in the parameter. Another disclosed method includes determining times at which a drilling system is conditioning the wellbore, measuring torque, hookload and drilling fluid pressure during conditioning, and generating a warning signal if one or more of maximum value of measured torque, torque variation, maximum value of drill string acceleration, maximum value of hookload and maximum value of drilling fluid pressure exceeds a selected threshold during reaming up motion of the drilling system.”

U.S. Pat. No. 7,139,218 discloses a “high-speed downhole network providing real-time data from downhole components of a drilling strings includes a bottom-hole node interfacing to a bottom-hole assembly located proximate the bottom end of a drill string. A top-hole node is connected proximate the top end of the drill string. One or several intermediate nodes are located along the drill string between the bottom-hole node and the top-hole node. The intermediate nodes are configured to receive and transmit data packets transmitted between the bottom-hole node and the top-hole node. A communications link, integrated into the drill string, is used to operably connect the bottom-hole node, the intermediate nodes, and the top-hole node. In selected embodiments, a personal or other computer may be connected to the top-hole node, to analyze data received from the intermediate and bottom-hole nodes.”

U.S. Pat. No. 7,139,689 discloses a “method for simulating a drilling tool assembly having a drill string and a drill bit. The method includes simulating a dynamic response of the drill string; simulating a dynamic response of the drill bit; and resolving the dynamic response of the drill string and the dynamic response of the drill bit into a dynamic response of the drilling tool assembly.”

U.S. Pat. No. 7,142,986 discloses a “method for optimizing drilling parameters includes obtaining previously acquired data, querying a remote data store for current well data, determining optimized drilling parameters, and returning optimized parameters for a next segment to the remote data store. Determining optimized drilling parameters may include correlating the current well data to the previously acquired data, predicting drilling conditions for the next segment, and optimizing drilling parameters for the next segment.”

U.S. Pat. No. 7,168,506 discloses “a method and apparatus for multiplexing data on-bit in a drilling operation. The apparatus comprises a bit; a plurality of transducers situated on the bit; and an analog multiplexer situated on the on the bit and capable of receiving the output of the transducers, multiplexing the received outputs, and transmitting the multiplexed outputs. The method comprises taking a plurality of measurements of at least one down-hole drilling condition at a bit of a drill string; generating a plurality of analog signals representative of the measurements; and multiplexing the analog signals at the bit.”

U.S. Pat. No. 7,172,037 discloses a “drilling control system [that] provides, in one aspect, advisory actions for optimal drilling. Such a system or model utilizes downhole dynamics data and surface drilling parameters, to produce drilling models used to provide to a human operator with recommended drilling parameters for optimized performance. In another aspect, the output of the drilling control system is directly linked with rig instrumentation systems so as to provide a closed-loop automated drilling control system that optimizes drilling while taking into account the downhole dynamic behavior and surface parameters. The drilling models can be either static or dynamic. In one embodiment, the simulation of the drilling process uses neural networks to estimate some nonlinear function using the examples of input-output relations produced by the drilling process.”

U.S. Pat. No. 7,182,154 discloses a “directional borehole drilling system [that] employs a controllable drill bit, which includes one or more conical drilling surfaces. Instrumentation located near the bit measures present position when the bit is static, and dynamic toolface when the bit is rotating. This data is processed to determine the error between the present position and a desired trajectory, and the position of one or more of the bit's leg assemblies is automatically changed as needed to make the bit bore in the direction necessary to reduce the error. The controllable drill bit preferably comprises three leg assemblies mounted about the bit's central axis, each leg having a “toed-out” axle. In response to a command signal, a lower leg translates along the bit axis to cause it to bear more of the bit weight, thus excavating more deeply over the commanded toolface sector and causing the bit to bore in a preferred direction.”

U.S. Pat. No. 7,211,909 discloses a “monolithic integrated circuit arrangement containing a substrate, a functional unit formed in and/or on the substrate, and an energy supply unit, which is formed in and/or on the substrate and is coupled to the functional unit and has an inductance and a permanent magnet. The inductance and the permanent magnet are arranged such that, under a vibration on the circuit arrangement, the permanent magnet is moved relative to the inductance such that an electrical induced voltage for supplying the functional unit with electrical energy is induced by the inductance.”

U.S. Pat. No. 7,219,728 discloses a “system that is usable with a subterranean well includes a first tubular member that is adapted to receive a flow of a first fluid. The system includes a second tubular member that is located in the flow and is substantially flexible to be moved by the flow to establish a pressure on a second fluid located inside the tubular member. A mechanism of the system uses this pressure to actuate a downhole tool.”

U.S. Pat. No. 7,219,747 discloses a “method and apparatus for providing a local response to a local condition in an oil well are disclosed. A sensor is provided to detect a local condition in a drill string. A controllable element is provided to modulate energy in the drill string. A controller is coupled to the sensor and to the controllable element. The controller receives a signal from the sensor, the signal indicating the presence of said local condition, processes the signal to determine a local energy modulation in the drill string to modify said local condition, and sends a signal to the controllable element to cause the determined local energy modulation.”

U.S. Pat. No. 7,225,886 discloses “a drill bit assembly [that] has a body portion intermediate a shank portion and a working portion. The working portion has a recess with a side wall which is substantially coaxial with the shank portion. At least one cutting element is attached to the side wall and an indenting member is disposed within the closed end. In another aspect of the invention a method includes providing a drill bit assembly with a recess formed in a working portion of the assembly. The working portion has a plurality of cutting elements and the recess has at least one cutting element. The method further has steps of cutting a formation with the plurality of cutting elements and also of penetrating a conical profile of the formation which is formed by the recess.”

U.S. Pat. No. 7,234,517 discloses a “system and method for determining load on a downhole tool according to which one or more sensors are embedded in one or more components of the tool or in a material on one or more of the components. The sensors are adapted to sense load on the components.”

U.S. Pat. No. 7,308,937 discloses an “expandable reamer apparatus and methods for reaming a borehole, wherein a laterally movable blade carried by a tubular body may be selectively positioned at an inward position and an expanded position. The laterally movable blade, held inwardly by blade-biasing elements, may be forced outwardly by drilling fluid selectively allowed to communicate therewith by way of an actuation sleeve disposed within the tubular body. Alternatively, a separation element may transmit force or pressure from the drilling fluid to the movable blade. Further, a chamber in communication with the movable blade may be pressurized by way of a downhole turbine or pump. A ridged seal wiper, compensator, movable bearing pad, fixed bearing pad preceding the movable blade, or adjustable spacer element to alter expanded blade position may be included within the expandable reamer. In addition, a drilling fluid pressure response indicating an operational characteristic of the expandable reamer may be generated.”

U.S. Pat. No. 7,398,837 discloses “a drill bit assembly [that] has a body portion intermediate a shank portion and a working portion. The working portion has at least one cutting element. In some embodiments, the drill bit assembly has a shaft with an end substantially coaxial to a central axis of the assembly. The end of the shaft substantially protrudes from the working portion, and at least one downhole logging device is disposed within or in communication with the shaft.”

U.S. Patent Application No. 20010054514 discloses a “drill bit for use in drilling operations in a wellbore, the drill bit having a bit body including a plurality of bit legs, each supporting a rolling cone cutter; a coupling member formed at an upper portion of said bit body; at least one temperature sensor for monitoring at least one temperature condition of said improved drill bit during drilling operations; and at least one temperature sensor cavity formed in said bit body and adapted for receiving, carrying, and locating said at least one temperature sensor in a particular position relative to said bit body which is empirically determined to optimize temperature sensor discrimination.”

U.S. Patent Application No. 20040069539 discloses an “improved drill bit for use in drilling operations in a wellbore comprising a bit body including a plurality of bit legs, each supporting a rolling cone cutter, a coupling member formed at an upper shank portion of said bit body, at least one sensor for monitoring at least one condition of said improved drill bit during drilling operations, and an electronics bay portion defined in-part by said upper shank portion of said bit body for housing at least one monitoring circuit.”

U.S. Patent Application No. 20040222018 discloses a “drill bit for use in drilling operations in a wellbore, the drill bit having a bit body including a plurality of bit legs, each supporting a rolling cone cutter; a coupling member formed at an upper portion of said bit body; at least one temperature sensor for monitoring at least one temperature condition of said improved drill bit during drilling operations; and at least one temperature sensor cavity formed in said bit body and adapted for receiving, carrying, and locating said at least one temperature sensor in a particular position relative to said bit body which is empirically determined to optimize temperature sensor discrimination.”

U.S. Patent Application No. 20050230149 discloses “a method and apparatus for multiplexing data on-bit in a drilling operation. The apparatus comprises a bit; a plurality of transducers situated on the bit; and an analog multiplexer situated on the on the bit and capable of receiving the output of the transducers, multiplexing the received outputs, and transmitting the multiplexed outputs. The method comprises taking a plurality of measurements of at least one down-hole drilling condition at a bit of a drill string; generating a plurality of analog signals representative of the measurements; and multiplexing the analog signals at the bit.”

International Patent Application No. WO2006133243 discloses “[d]rill bits and methods for sampling sensor data associated with the state of a drill bit are disclosed. A drill bit (200) for drilling a subterranean formation comprises a bit body and a shank (210). The shank further includes a central bore formed through an inside diameter of the shank and configured for receiving a data analysis module. The data analysis module comprises a plurality of sensors (340), a memory (330), and a processor (320). The processor is configured for executing computer instructions to collect the sensor data by sampling the plurality of sensors, analyze the sensor data to develop a severity index, compare the sensor data to at least one adaptive threshold, and modify a data sampling mode responsive to the comparison. A method comprises collecting sensor data by sampling a plurality of physical parameters associated with a drill bit state while in various sampling modes and transitioning between those sampling modes.”

European Patent No. EP728915 discloses “an improved method and apparatus for monitoring and recording of operating conditions of a downhole drill bit during drilling operations. The invention may be alternatively characterized as either (1) an improved downhole drill bit, or (2) a method of monitoring at least one operating condition of a downhole drill bit during drilling operations in a wellbore, or (3) a method of manufacturing an improved downhole drill bit. When characterized as an improved downhole drill bit, the present invention includes (1) an assembly including at least one bit body, (2) a coupling member formed at an upper portion of the assembly, (3) at least one operating conditioning sensor carried by the improved downhole drill bit for monitoring at least one operating condition during drilling operations, and (4) at least one memory means, located in and carried by the drill bit body, for recording in memory data pertaining to the at least one operating condition. Optionally, the improved downhole drill bit of the present invention may cooperate with a communication system for communicating information away from the improved downhole drill bit during drilling operations, preferably ultimately to a surface location. The improved downhole drill bit of the present invention may further include a processor member, which is located in and carried by the drill bit body, for performing at least one predefined analysis of the data pertaining to the at least one operating condition, which has been recorded by the at least one memory means.”

European Patent Application No. EP1632643 discloses “an improved method and apparatus for monitoring and recording of operating conditions of a downhole drill bit during drilling operations. The invention may be alternatively characterized as either (1) an improved downhole drill bit, or (2) a method of monitoring at least one operating condition of a downhole drill bit during drilling operations in a wellbore, or (3) a method of manufacturing an improved downhole drill bit. When characterized as an improved downhole drill bit, the present invention includes (1) an assembly including at least one bit body, (2) a coupling member formed at an upper portion of the assembly, (3) at least one operating conditioning sensor carried by the improved downhole drill bit for monitoring at least one operating condition during drilling operations, and (4) at least one memory means, located in and carried by the drill bit body, for recording in memory data pertaining to the at least one operating condition. Optionally, the improved downhole drill bit of the present invention may cooperate with a communication system for communicating information away from the improved downhole drill bit during drilling operations, preferably ultimately to a surface location. The improved downhole drill bit of the present invention may further include a processor member, which is located in and carried by the drill bit body, for performing at least one predefined analysis of the data pertaining to the at least one operating condition, which has been recorded by the at least one memory means.”

European Patent Application No. EP1632644 discloses “an improved method and apparatus for monitoring and recording of operating conditions of a downhole drill bit during drilling operations. The invention may be alternatively characterized as either (1) an improved downhole drill bit, or (2) a method of monitoring at least one operating condition of a downhole drill bit during drilling operations in a wellbore, or (3) a method of manufacturing an improved downhole drill bit. When characterized as an improved downhole drill bit, the present invention includes (1) an assembly including at least one bit body, (2) a coupling member formed at an upper portion of the assembly, (3) at least one operating conditioning sensor carried by the improved downhole drill bit for monitoring at least one operating condition during drilling operations, and (4) at least one memory means, located in and carried by the drill bit body, for recording in memory data pertaining to the at least one operating condition. Optionally, the improved downhole drill bit of the present invention may cooperate with a communication system for communicating information away from the improved downhole drill bit during drilling operations, preferably ultimately to a surface location. The improved downhole drill bit of the present invention may further include a processor member, which is located in and carried by the drill bit body, for performing at least one predefined analysis of the data pertaining to the at least one operating condition, which has been recorded by the at least one memory means.”

The inventions disclosed and taught herein are directed to methods and systems for the design and optimization of reamer tools used in bottomhole assemblies.

### BRIEF SUMMARY OF THE INVENTION

The present invention relates to methods and systems for optimizing the design of a bottomhole assembly, a reamer tool or other component of the bottomhole assembly, and/or drilling parameters of the bottomhole assembly. The method may include placing electronic modules in pockets of or adjacent to the reamer tool; reaming a borehole with the reamer tool while the modules record and store data for later retrieval; and then retrieving the data from the modules to optimize the design of the reamer tool. In one embodiment, the modules may record vibration along three axis. The reamer tool may be a concentric reamer, an eccentric reamer, or virtually any type of reamer known in the art. In some embodiments, the bottomhole assembly may utilize a roller cone or drag bit below the reamer tool as a pilot bit.

The present invention also relates to a bottomhole assembly comprising: a pilot drill bit; a reamer tool above the drill bit; and one or more electronic modules in one or more pockets of a pin and/or box connector of the reamer tool. In one embodiment, the modules may record vibration along three axis for retrieval after the bottomhole assembly has been removed from a borehole. The bottomhole assembly may be substantially the same length as it would be without the devices. Because one of the goals of the present invention is to optimize reamer tool design, the modules need not transmit the data to the surface while in the bottomhole assembly.

### BRIEF DESCRIPTION OF THE SEVERAL VIEWS OF THE DRAWINGS

FIG. 1A illustrates a bottomhole assembly utilizing certain aspects of the present inventions, the bottomhole assembly being shown in pass through condition;

FIG. 1B illustrates a bottomhole assembly utilizing certain aspects of the present inventions, the bottomhole assembly being shown in start up condition;

FIG. 1C illustrates a bottomhole assembly utilizing certain aspects of the present inventions, bottomhole assembly being shown in a normal drilling mode for enlarging a borehole;

FIG. 2A is a longitudinal cross-sectional view of a fixed blade reamer that may form part of a bottomhole assembly utilizing certain aspects of the present inventions;

FIG. 2B shows a bottom view of the reamer of FIG. 2A;

FIG. 3A illustrates a side cross-sectional view of a particular embodiment of a first embodiment of an expandable reamer that may form part of a bottomhole assembly utilizing certain aspects of the present inventions, the reamer being shown in a contracted state;

FIG. 3B illustrates a side cross-sectional view of a particular embodiment of a first embodiment of an expandable reamer that may form part of a bottomhole assembly utilizing certain aspects of the present inventions, the reamer being shown in an expanded state;

FIG. 4A is a side view of a second embodiment of an expandable reamer that may form part of a bottomhole assembly utilizing certain aspects of the present inventions;

FIG. 4B shows a transverse cross-sectional view of the expandable reamer as indicated by section line 4B-4B in FIG. 4A;

FIG. 4C shows a longitudinal cross-sectional view of the expandable reamer indicated by section line 4C-4C in FIG. 4B;

FIG. 5 illustrates a perspective view of a drill bit shank, an exemplary electronics module, and an end-cap that may form part of a bottomhole assembly utilizing certain aspects of the present inventions;

FIG. 6 illustrates a conceptual perspective view of an exemplary electronic module configured as a flex-circuit board enabling formation into an annular ring suitable for disposition in the shank of FIG. 5;

FIG. 7 illustrates a block diagram of an exemplary embodiment of a data analysis module utilizing certain aspects of the present invention;

FIG. 8 illustrates a perspective view of a reamer tool pin connection, an exemplary electronics module, and an end-cap that may form part of a bottomhole assembly utilizing certain aspects of the present inventions;

FIG. 9 illustrates a conceptual side cross-sectional view of a particular embodiment of a reamer tool pin connection that may form part of a bottomhole assembly utilizing certain aspects of the present inventions; and

FIG. 10 illustrates a conceptual side cross-sectional view of a particular embodiment of a reamer tool box connection that may form part of a bottomhole assembly utilizing certain aspects of the present inventions.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

We have created methods and systems for optimizing the design of a bottomhole assembly, a reamer tool or other component of the bottomhole assembly, and/or drilling parameters of the bottomhole assembly. The method may include placing electronic modules in pockets of or adjacent to the reamer tool; reaming a borehole with the reamer tool while the modules record and store data for later retrieval; and then retrieving the data from the modules to optimize the design of the reamer tool. In one embodiment, the modules may record vibration along three axis. The reamer tool may be a concentric reamer, an eccentric reamer, or virtually any type of reamer known in the art. In some embodiments, the reamer tool is part of a bottomhole assembly, which may utilize a roller cone or drag bit below the reamer tool as a pilot bit.

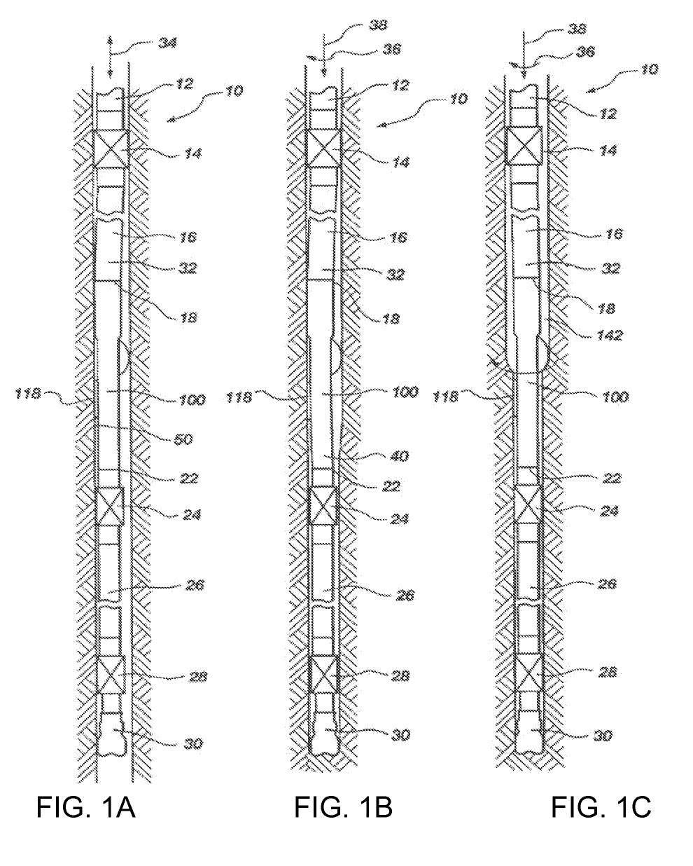

FIG. 1A, FIG. 1B, and FIG. 1C depict an exemplary bottomhole assembly 10 with an eccentric reamer tool 100, such as that disclosed in U.S. Pat. No. 5,497,842, the disclosure of which is incorporated herein by reference. The bottomhole assembly 10 may be similar to that disclosed in U.S. Pat. No. 5,765,653, the disclosure of which is incorporated herein by reference.

Commencing with FIG. 1A and moving from the top to the bottom of the assembly 10, one or more drill collars 12 are suspended from the distal end of a drill string extending to the rig floor at the surface. A pass through stabilizer 14 may be secured to drill collar 12, stabilizer 14 being sized equal to or slightly smaller than the pass through diameter of the bottomhole assembly 10, which may be defined as the smallest diameter borehole through which the assembly may move longitudinally. Another drill collar 16, or other drill string element such as an measurement with drilling (MWD) tool housing or pony collar, is secured to the bottom of stabilizer 14, below which the reamer tool 100 including a stabilization pad 118 is secured via tool joint 18. Another API joint 22 is located at the bottom of the reamer tool 100. An upper pilot stabilizer 24, secured to the reamer tool 100, is of an O.D. equal to or slightly smaller than that of the pilot bit at the bottom of the assembly 10. Yet another, smaller diameter drill collar 26 is secured to the lower end of pilot stabilizer 24, followed by a lower pilot stabilizer 28 to which is secured pilot bit 30. Pilot bit 30 may be either a rotary drag bit or a tri-cone, or roller cone, bit. The bottomhole assembly 10 as described is exemplary only, it being appreciated by those of ordinary skill in the art that many other assemblies and variations may be employed.

It should be noted that there is an upper lateral displacement 32 between the axis of the pass through stabilizer 14 and that of the reamer tool 100, which displacement is provided by the presence of drill collar 16 therebetween and which promotes passage of the assembly 10, and particularly the reamer tool 100, through a borehole segment of the design pass through diameter.

In pass through condition, shown in FIG. 1A, the assembly 10 is always in either tension or compression, depending upon the direction of travel, as shown by arrow 34. Contact of the assembly with the borehole wall 50 is primarily through pass through stabilizer 14 and the reamer tool 100. The assembly 10 is not normally rotated while in pass through condition.

FIG. 1B depicts start up condition of assembly 10, wherein assembly 10 is rotated by application of torque as shown by arrow 36 as weight-on-bit (WOB) is also applied to the string, as shown by arrow 38. As shown, pilot bit 30 has drilled ahead into the uncut formation to a depth approximating the position of upper pilot stabilizer 24, but the reamer tool 100 has yet to commence enlarging the borehole to drill diameter. As shown at 32 and at 40, the axis of the reamer tool 100 is laterally displaced from those of both pass through stabilizer 14 and upper pilot stabilizer 24. In this condition, the reamer tool 100 has not yet begun its transition from being centered about a pass through center line to its drilling mode center line which is aligned with that of pilot bit 30.

FIG. 1C depicts the normal drilling mode of bottomhole assembly 10, wherein torque 36 and WOB 38 are applied. Upper displacement 32 may remain as shown, but generally is eliminated under all but the most severe drilling conditions. Lower displacement 40 has been eliminated as the reamer tool 100 is rotating about the same axis as pilot bit 30 in cutting the borehole to full drill diameter. It is readily apparent from FIG. 1C that concentric stabilizer 14 (if employed) performs only a nominal stabilization function once enlargement of the borehole is fully underway and stabilizer 14 has passed into the enlarged segment of the borehole. In such circumstances, the aforementioned drill string “whip” is experienced due to effective contact of the string with the borehole wall being limited to only one lateral or radial location.

Expandable concentric stabilizers may be employed to effect better stabilization of the bottomhole assembly 10 in the enlarge borehole, the diameter of which stabilizers may be increased by string manipulation or hydraulically once the stabilizer has reached an enlarged portion of the borehole. One such device being disclosed in U.S. Pat. No. 4,854,403, the disclosure of which is incorporated herein by reference. Such devices, however, are relatively complex and expensive, and may fail to contract after expansion, impeding or preventing the trip out of the borehole.

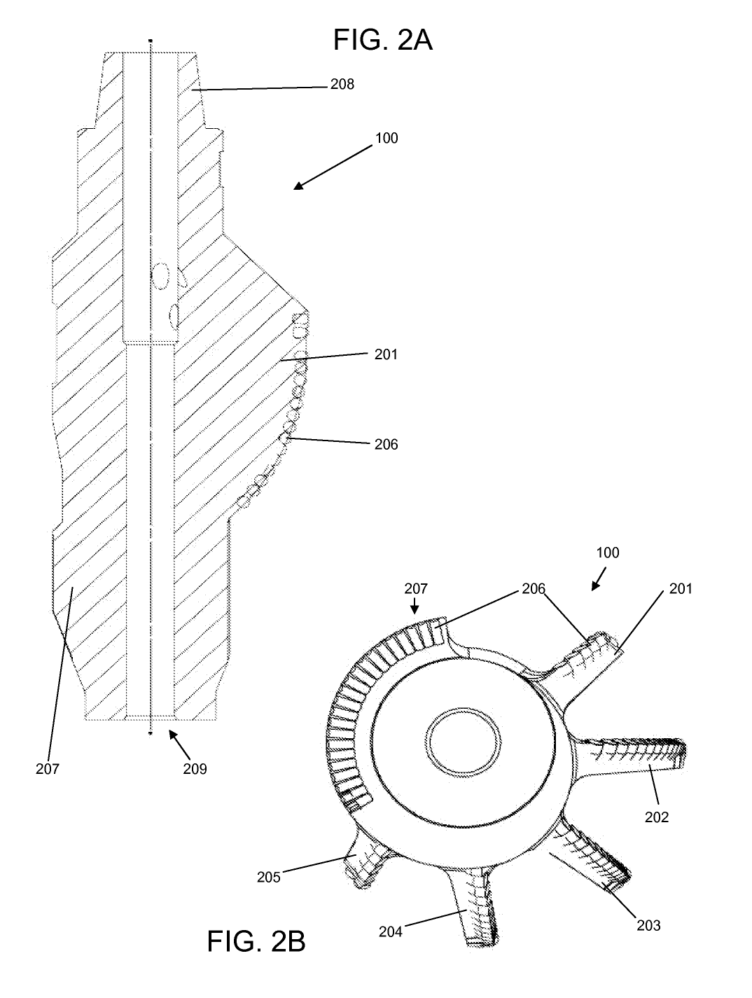

The reamer tool 100 may be a fixed blade eccentric reamer, such as that shown in FIG. 2A and FIG. 2B. In this embodiment, the reamer tool 100 has a number of blades 201,202,203,204,205 occupying approximately half the circumference of the tool 100. Each blade 201,202,203,204,205 is lined with cutting elements 206, such as polycrystalline diamond compact (PDC) cutters discussed in greater detail below. Opposing the blades 201,202,203,204,205, is preferably a pilot stabilization pad 207 which offsets the net imbalance force created by the blades 201,202,203,204,205. The pilot stabilization pad 207 forces rotation around the pilot hole center, ensuring a full-size hole is drilled. The pilot stabilization pad 207 may also have cutting elements 206 embedded within to increase durability. In this embodiment, the reamer tool 100, preferably includes a male pin connection 208 and a female box connection 209.

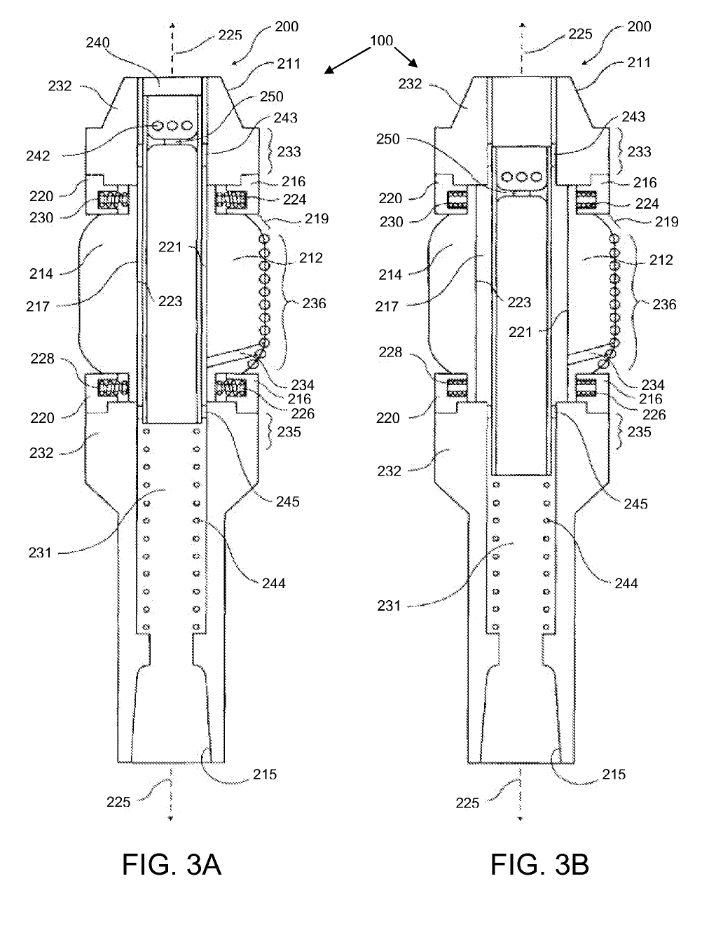

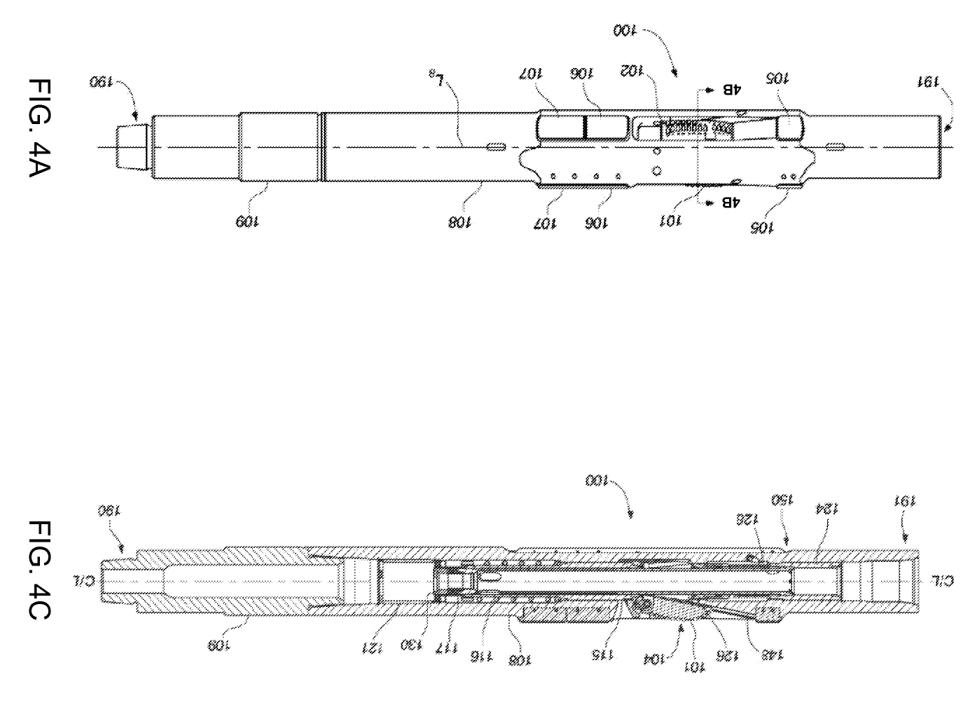

Rather than the fixed blade eccentric reamer tool discussed above, the reamer tool 100 may be a concentric and/or expandable reamer. For Example, FIG. 3A and FIG. 3B show an expandable reamer 200 of the present invention. The expandable reamer 200 may be similar to that disclosed in U.S. Pat. No. 7,036,611, the disclosure of which is incorporated herein by reference. The expandable reamer 200 includes a tubular body 232 with a bore 231 extending therethrough, having movable blades 212 and 214 outwardly spaced from the centerline or longitudinal axis 225 of the tubular body 232. The tubular body 232 includes a male-threaded pin connection 211 as well as a female-threaded box connection 215, as known in the art. Movable blades 212 and 214 may each carry a plurality of cutting elements 236. Cutting elements 236 are shown only on movable blade 212, as the cutting elements on movable blade 214 would be facing in the direction of rotation of the expandable reamer 200 and, therefore, may not be visible in the view depicted in FIG. 3A. Cutting elements 236 may comprise PDC cutting elements, thermally stable PDC cutting elements (also known as “TSPs”), superabrasive impregnated cutting elements, tungsten carbide cutting elements, and any other known cutting element of a material and design suitable for the subterranean formation through which a borehole is to be reamed using the reamer tool 100. One particularly suitable superabrasive impregnated cutting element is disclosed in U.S. Pat. No. 6,510,906, the disclosure of which is incorporated herein by reference. It is also contemplated that, if PDC cutting elements are employed, they may be positioned on a blade so, as to be circumferentially and rotationally offset from a radially outer, rotationally leading edge portion of a blade where a casing contact point is to occur. Such positioning of the cutters rotationally, or circumferentially, to the rotational rear of the casing contact point located on the radially outermost leading edge of the blade allows the cutters to remain on proper drill diameter for enlarging the borehole, but are, in effect, recessed away from the casing contact point.

Actuation sleeve 240 may be positioned longitudinally in a first position, where apertures 242 are above actuation seal 243. Drilling fluid (not shown) may pass through actuation sleeve 240, thus passing by movable blades 212 and 214. Actuation seal 243 and lower sleeve seal 245 may prevent drilling fluid from interacting with movable blades 212 and 214. Further, sleeve-biasing element 244 may provide a bias force to actuation sleeve 240 to maintain its longitudinal position. However, as drilling fluid passes through actuation sleeve 240, a reduced cross-sectional orifice 250 may produce a force upon the actuation sleeve 240. As known in the art, drag of the drilling fluid through the reduced cross-sectional orifice 250 may cause a downward longitudinal force to develop on the actuation sleeve 240. As the drilling fluid force on the actuation sleeve 240 exceeds the force generated by the sleeve-biasing element 244, the actuation sleeve 240 may move longitudinally downward thereagainst. Thus, the longitudinal position of the actuation sleeve 240 may be modified by way of changing the flow rate of the drilling fluid passing therethrough. Alternatively, a collet or shear pins (not shown) may be used to resist the downward longitudinal force until the shear point of the shear pin or frictional force of the collet is exceeded. Thus, the downward longitudinal force generated by the drilling fluid moving through the reduced cross-sectional area orifice 250 may cause a friable or frictional element to release the actuation sleeve 240 and may cause the actuation sleeve 240 to move longitudinally downward.

Further, the longitudinal position of the actuation sleeve 240 may allow drilling fluid to be diverted to the inner surfaces 221 and 223 of movable blades 212 and 214, respectively, via apertures or ports 242. In opposition to the force of the drilling fluid upon the inner surfaces 221 and 223 of movable blades 212 and 214, blade-biasing elements 224, 226, 228, and 230 may be configured to provide an inward radial or lateral force upon movable blades 212 and 214. However, drilling fluid acting upon the inner surfaces 221 and 223 may generate a force that exceeds the force applied to the movable blades 212 and 214 by way of the blade-biasing elements 224, 226, 228, and 230, and movable blades 212 and 214 may, therefore, move radially or laterally outwardly. Thus, the reamer tool 100 is shown in an expanded state in FIG. 3B, wherein movable blades 212 and 214 are disposed at their outermost radial or lateral position.

Thus, FIG. 3B shows an operational state of expandable reamer 200 wherein actuation sleeve 240 is positioned longitudinally so that apertures or ports 242 allow drilling fluid flowing through the reamer tool 100 to pressurize the annulus 217 formed between the outer surface of actuation sleeve 40 and inner radial surface of movable blades 212 and 214 to force movable blade 212 against blade-biasing elements 224 and 226, as well as forcing movable blade 14 against blade-biasing elements 228 and 230. Further, the pressure applied to the inner surfaces 221 and 223 may be sufficient so that movable blade 212 compresses blade-biasing elements 224 and 226 and may matingly engage the inner radial surface of retention element 216 as shown in FIG. 3B. Regions 233 and 235 indicate a portion of the tubular body 232 that may contain holes for disposing removable lock rods (not shown) for affixing retention element 216 and movable blade 212 thereto. Likewise, the pressure applied to the inner surfaces 221 and 223 may be sufficient so that movable blade 214 compresses blade-biasing elements 228 and 230 and may matingly engage the radial inner surface of retention element 220 as shown in FIG. 3B. Thus, the movable blades 212 and 214 of the reamer tool 100 of the present invention may be caused to expand to an outermost radial or lateral position and the borehole may be enlarged by the combination of rotation and longitudinal displacement of the reamer tool 100.

Further, at least one movable blade 212 of the expandable reamer 200 may be configured with a port 234 to aid in cleaning the formation cuttings from the cutting elements 236 affixed to the movable blades 212 and 214 during reaming. As shown in FIGS. 3A and 3B, a port 234 may be configured near the lower longitudinal cutting elements 236 on movable blade 212 and may be oriented, for example, 15 degrees from horizontal, toward the upper longitudinal end of the reamer tool 100. Alternatively, a port 234 may be installed in the horizontal direction, substantially perpendicular to the longitudinal axis 225 of tubular body 232 of the reamer tool 100. Of course, the present invention contemplates that a port 234 may be oriented as desired. Other configurations for communicating fluid from the interior of the tubular body 232 to the cutting elements 236 on the movable blades 212 and 214 are contemplated, including a plurality of ports 234 on at least one movable blade.

Movable blades 212 and 214 may also be caused to contract radially or laterally. For instance, as the drilling fluid pressure decreases, blade-biasing elements 224, 226, 228, and 230 may exert a radial or lateral inward force to bias movable blades 212 and 214 radially or laterally inward. In addition, taper 219 may facilitate movable blades 212 and 214 returning radially or laterally inwardly during tripping out of the borehole if the blade-biasing elements 224, 226, 228, and 230 fail to do so. Specifically, impacts between the borehole and the taper 219 may tend to move the movable blades 212 and 214 radially or laterally inward.

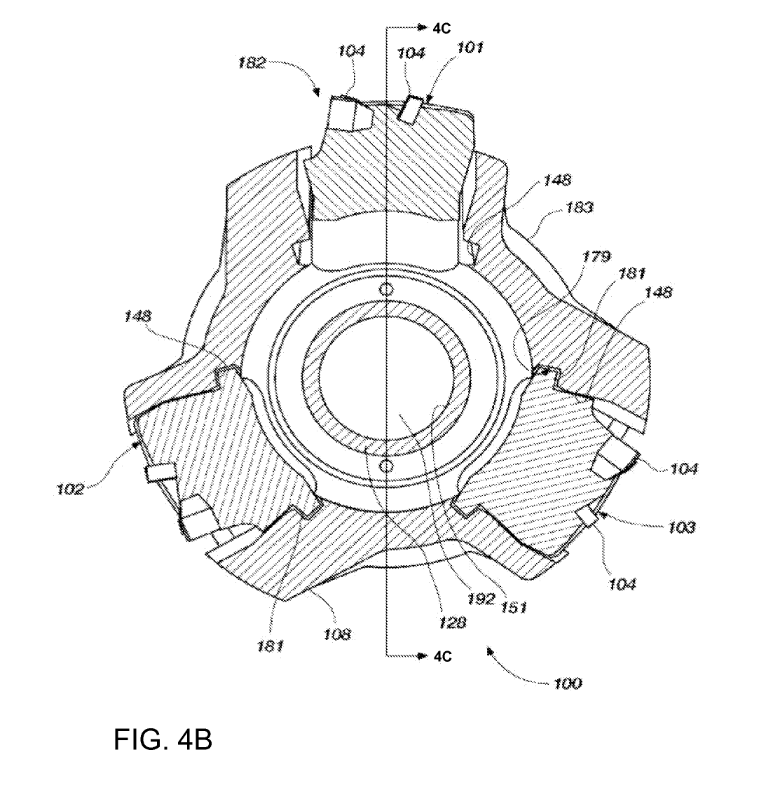

In one preferred embodiment, the reamer tool 100 is similar to that disclosed in U.S. Patent Application Publication No. 20080128175, the disclosure of which is incorporated herein by reference. An expandable reamer tool 100 according to an embodiment of the invention is shown in FIG. 4A, FIG. 4B, and FIG. 4C. The expandable reamer tool 100 may include a generally cylindrical tubular body 108 having a longitudinal axis L₈. The tubular body 108 of the expandable reamer tool 100 may have a lower end 190 and an upper end 191. The terms “lower” and “upper,” as used herein with reference to the ends 190, 191, refer to the typical positions of the ends 190, 191 relative to one another when the expandable reamer apparatus 100 is positioned within a well bore. The lower end 190 of the tubular body 108 of the expandable reamer tool 100 may include a set of threads (e.g., a threaded male pin member) for connecting the lower end 190 to another section of a drill string or another component of the bottomhole assembly 10, such as, for example, a drill collar or collars carrying the pilot drill bit 30 for drilling the well bore. Similarly, the upper end 191 of the tubular body 108 of the expandable reamer tool 100 may include a set of threads (e.g., a threaded female box member) for connecting the upper end 191 to another section of a drill string or another component of the assembly 10.

Referring also the FIG. 4B, three sliding cutter blocks or blades 101, 102, 103 may be positionally retained in circumferentially spaced relationship in the tubular body 108 and may be provided at a position along the expandable reamer tool 100 intermediate the first lower end 190 and the second upper end 191. The blades 101, 102, 103 may be comprised of steel, tungsten carbide, a particle-matrix composite material (e.g., hard particles dispersed throughout a metal matrix material), or other suitable materials as known in the art. The blades 101, 102, 103 are retained in an initial, retracted position within the tubular body 108 of the expandable reamer apparatus 100, but may be moved responsive to application of hydraulic pressure into the extended position and moved into a retracted position when desired. The expandable reamer tool 100 may be configured such that the blades 101, 102, 103 engage the walls of a subterranean formation surrounding a well bore in which tool 100 is disposed to remove formation material when the blades 101, 102, 103 are in the extended position, but are not operable to so engage the walls of a subterranean formation within a well bore when the blades 101, 102, 103 are in the retracted position. While the expandable reamer tool 100 includes three blades 101, 102, 103, it is contemplated that one, two or more than three blades may be utilized to advantage. Moreover, while the blades 101, 102, 103 are symmetrically circumferentially positioned axial along the tubular body 108, the blades may also be positioned circumferentially asymmetrically as well as asymmetrically along the longitudinal axis L₈ in the direction of either end 190 and 191.

The tubular body 108 encloses a fluid passageway 192 that extends longitudinally through the tubular body 108. The fluid passageway 192 directs fluid substantially through an inner bore 151 of a traveling sleeve 128 in bypassing relationship to substantially shield the blades 101, 102, 103 from exposure to drilling fluid, particularly in the lateral direction, or normal to the longitudinal axis L₈. Advantageously, the particulate-entrained fluid is less likely to cause build-up or interfere with the operational aspects of the expandable reamer apparatus 100 by shielding the blades 101, 102, 103 from exposure with the fluid. However, it is recognized that beneficial shielding of the blades 101, 102, 103 is not necessary to the operation of the expandable reamer apparatus 100 where, as explained in further detail below, the operation, i.e., extension from the initial position, the extended position and the retracted position, occurs by an axially directed force that is the net effect of the fluid pressure and spring biases forces. In this embodiment, the axially directed force directly actuates the blades 101, 102, 103 by axially influencing the actuating means, such as a push sleeve 115 (shown in FIG. 4C) for example, and without limitation.

To better describe aspects of the invention blades 102 and 103 are shown in the initial or retracted positions, while blade 101 is shown in the outward or extended position. The expandable reamer tool 100 may be configured such that the outermost radial or lateral extent of each of the blades 101, 102, 103 is recessed within the tubular body 108 when in the initial or retracted positions so it may not extend beyond the greatest extent of outer diameter of the tubular body 108. Such an arrangement may protect the blades 101, 102, 103 as the expandable reamer tool 100 is disposed within a casing of a borehole, and may allow the expandable reamer tool 100 to pass through such casing within a borehole. In other embodiments, the outermost radial extent of the blades 101, 102, 103 may coincide with or slightly extend beyond the outer diameter of the tubular body 108. As illustrated by blade 101, the blades may extend beyond the outer diameter of the tubular body 108 when in the extended position, to engage the walls of a borehole in a reaming operation.

Referring also to FIG. 4C, the tubular body 108 positionally respectively retains three sliding cutter blocks or blades 101, 102, 103 in three blade tracks 148. The blades 101, 102, 103 each carry a plurality of cutting elements 104 for engaging the material of a subterranean formation defining the wall of an open bore hole when the blades 101, 102, 103 are in an extended position. The cutting elements 104 may be PDC cutters or other cutting elements known to a person of ordinary skill in the art and as generally described in U.S. Pat. No. 7,036,611, the disclosure of which is incorporated by reference herein.

In order that the blades 101, 102, 103 may transition between the extended and retracted positions, they are each positionally coupled to one of the blade tracks 148 in the tubular body 108. The blade track 148 includes a dovetailed shaped groove 179 that axially extends along the tubular body 108 on a slanted slope having an acute angle with respect to the longitudinal axis L₈. Each of the blades 101, 102, 103 include a dovetailed shaped rail 181 that substantially matches the dovetailed shaped groove 179 of the blade track 148 in order to slideably secure the blades 101, 102, 103 to the tubular body 108. In order for the push sleeve 115 to move in the uphole direction, the differential pressure between the inner bore 151 and the outer side 183 of the tubular body 108 caused by the hydraulic fluid flow must be sufficient to overcome the restoring force or bias of a spring 116. When the push sleeve 115 is influenced by the hydraulic pressure, the blades 101, 102, 103 will be extended upward and outward through a blade passage port 182 into the extended position ready for cutting the formation. The blades 101, 102, 103 are pushed along the blade tracks 148 until the forward motion is stopped by the tubular body 108 or the upper stabilizer block 105 being coupled to the tubular body 108. In the upward-outward or fully extended position, the blades 101, 102, 103 are positioned such that the cutting elements 104 will enlarge a bore hole in the subterranean formation by a prescribed amount. When hydraulic pressure provided by drilling fluid flow through expandable reamer tool 100 is released, the spring 116 will urge the blades 101, 102, 103 via the push sleeve 115 and a pinned linkage into the retracted position. Should the assembly not readily retract via spring force, when the tool is pulled up the borehole to a casing shoe, the shoe may contact the blades 101, 102, 103 helping to urge or force them down the tracks 148, allowing the expandable reamer tool 100 to be retrieved from the borehole. In this respect, the expandable reamer tool 100 includes retraction assurance feature to further assist in removing the expandable reamer apparatus from a bore hole. The slope of blade tracks 148 in this embodiment of the invention is ten degrees, taken with respect to the longitudinal axis L₈ of the expandable reamer tool 100. While the slope of the blade tracks 148 is ten degrees, it may vary from a greater extent to a lesser extent than that illustrated. However, the slope should be less than substantially 35 degrees, to obtain the full benefit of this aspect of the invention. The blades 101, 102, 103, being “locked” into the blade tracks 148 with the dovetail shaped rails 181 as they are axially driven into the extended position permits looser tolerances as compared to conventional hydraulic reamers which required close tolerances between the blade pistons and the tubular body to radially drive the blade pistons into their extended position. Accordingly, the blades 101, 102, 103 are more robust and less likely to bind or fail due to blockage from the fluid. In this embodiment of the invention, the blades 101, 102, 103 have ample clearance in the grooves 179 of the blade tracks 148, such as a 1/16 inch clearance, more or less, between the dovetail-shaped rail 181 and dovetail-shaped groove 179. It is to be recognized that the term “dovetail” when making reference to the groove 179 or the rail 181 is not to be limiting, but is directed broadly toward structures in which each blade 101, 102, 103 is retained with the body 108 of the expandable reamer tool 100, while further allowing the blades 101, 102, 103 to transition between two or more positions along the blade tracks 148 without binding or mechanical locking.

In addition to the upper stabilizer block 105, the expandable reamer tool 100 also includes a mid stabilizer block 106 and a lower stabilizer block 107. Optionally, the mid stabilizer block 106 and the lower stabilizer block 107 may be combined into a unitary stabilizer block. The stabilizer blocks 105, 106, 107 help to center the expandable reamer tool 100 in the drill hole while being run into position through a casing or liner string and also while drilling and reaming the borehole. As mentioned above, the upper stabilizer block 105 may be used to stop or limit the forward motion of the blades 101, 102, 103, determining the extent to which the blades 101, 102, 103 may engage a bore hole while drilling. The upper stabilizer block 105, in addition to providing a back stop for limiting the lateral extent of the blades, may provide for additional stability when the blades 101, 102, 103 are retracted and the expandable reamer tool 100 of a drill string is positioned within a bore hole in an area where an expanded hole is not desired while the drill string is rotating.

The expandable reamer tool 100 may include a lower saver sub 109 that connects to the lower box connection of the reamer body 108. Allowing the body 108 to be a single piece design, the saver sub 109 enables the connection between the two to be stronger (has higher makeup torque) than a conventional two piece tool having an upper and a lower connection. The saver sub 109, although not required, provides for more efficient connection to other downhole equipment or tools.

A downhole end of the traveling sleeve 128, which includes a seat stop sleeve 130, is aligned, axially guided and supported by an annular piston or lowlock sleeve 117. The lowlock sleeve 117 is axially coupled to a push sleeve 115 that is cylindrically retained between the traveling sleeve 128 and the inner bore 151 of the tubular body 108. In order to support the traveling sleeve 128 and mitigate vibration effects after the traveling sleeve 128 is axially retained, the seat stop sleeve 130 and the downhole end of the traveling sleeve 128 are retained in a stabilizer sleeve. The stabilizer sleeve is coupled to the inner bore 151 of the tubular body 108 and retained between a retaining ring and a protect sleeve 121, which is held by an annular lip in the inner bore 151 of the tubular body 108. The expandable reamer tool 100 may also include a shear assembly 150 for retaining the expandable reamer tool 100 in the initial position by securing the traveling sleeve 128 toward the upper end 191 thereof. The shear assembly 150 includes an uplock sleeve 124, some number of shear screws and the traveling sleeve 128.

In any case, whether the reamer tool 100 is eccentric, concentric, and/or expandable, and whether the pilot bit 30 is a roller cone or drag bit, one can appreciate that the borehole environment is a very demanding workplace. More specifically, the entire bottomhole assembly 10 is subjected to incredible forces, which often lead to premature wear, destruction, and/or other damage to the bottomhole assembly 10 and components thereof. As a result, it is advantageous to characterize the borehole environment as well as the forces and other influences affecting the bottomhole assembly 10 and components thereof. The characterization can be used to optimize the reamer tool 100 and/or other components of the bottomhole assembly 10.

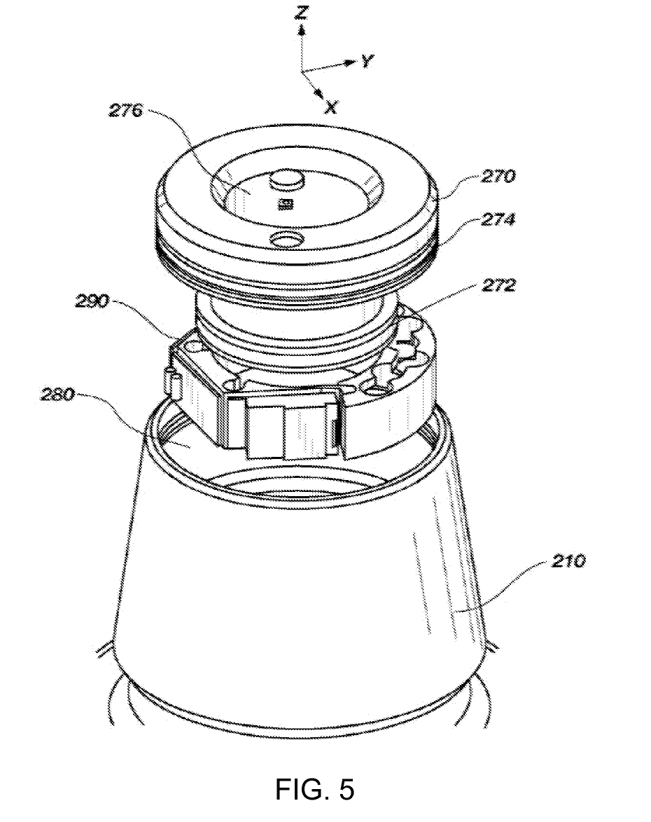

Such characterization can be done with monitoring devices, such as that described in U.S. Patent Application publication No. 20080060848, the disclosure of which is incorporated herein by reference. For example, FIG. 5 shows an exemplary embodiment of a shank 210 of a drill bit, such as the pilot bit 30, an end-cap 270, and an exemplary embodiment of an electronics module 290. The shank 210 includes a central bore 280 formed through the longitudinal axis of the shank 210. In conventional drill bits, this central bore 280 is configured for allowing drilling mud to flow therethrough. In the present invention, a portion of the central bore 280 is given a diameter sufficient for accepting the electronics module 290 configured in a substantially annular ring, yet without substantially affecting the structural integrity of the shank 210. Thus, the electronics module 290 may be placed down in the central bore 280, about the end-cap 270, which extends through the inside diameter of the annular ring of the electronics module 290 to create a fluid tight annular chamber 260 with the wall of central bore 280 and seal the electronics module 290 in place within the shank 210.

The end-cap 270 includes a cap bore 276 formed therethrough, such that the drilling mud may flow through the end cap, through the central bore 280 of the shank 210 to the other side of the shank 210, and then into the body of drill bit. In addition, the end-cap 270 includes a first flange 271 including a first sealing ring 272, near the lower end of the end-cap 270, and a second flange 273 including a second sealing ring 274, near the upper end of the end-cap 270.

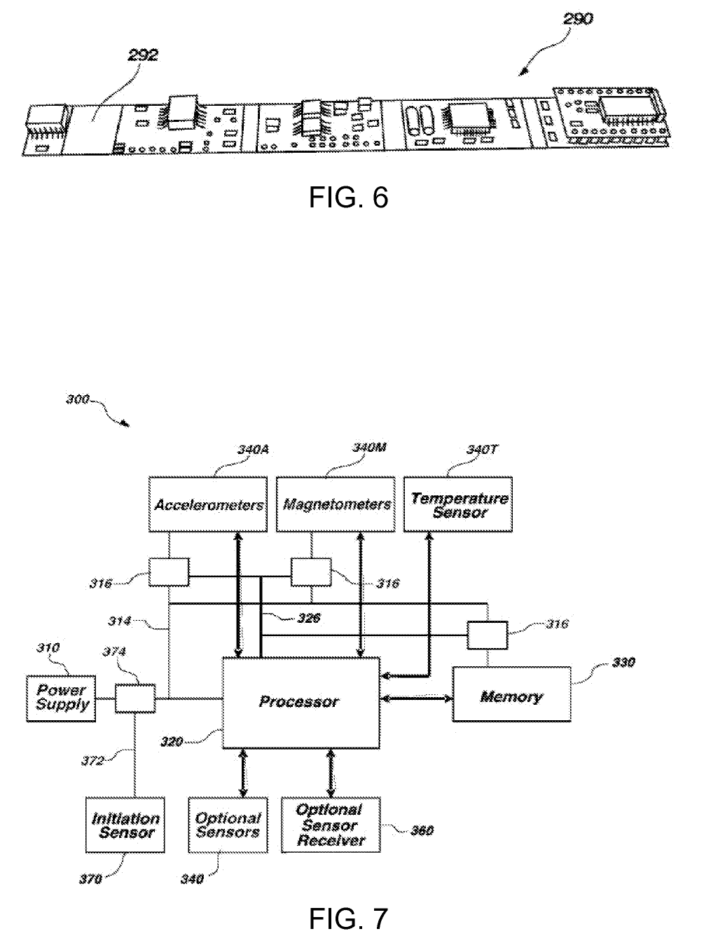

The electronics module 290 may be configured as a flex-circuit board, enabling the formation of the electronics module 290 into the annular ring suitable for disposition about the end-cap 270 and into the central bore 280. This flex-circuit board embodiment of the electronics module 290 is shown in a flat uncurled configuration in FIG. 6. The flex-circuit board 292 includes a high-strength reinforced backbone (not shown) to provide acceptable transmissibility of acceleration effects to sensors such as accelerometers. In addition, other areas of the flex-circuit board 292 bearing non-sensor electronic components may be attached to the end-cap 270 in a manner suitable for at least partially attenuating the acceleration effects experienced by the drill bit 200 during drilling operations using a material such as a visco-elastic adhesive.

The electronics module 290 may be configured to perform a variety of functions. One exemplary electronics module 290 may be configured as a data analysis module, which is configured for sampling data in different sampling modes, sampling data at different sampling frequencies, and analyzing data.

An exemplary data analysis module 300 is illustrated in FIG. 7. The data analysis module 300 includes a power supply 310, a processor 320, a memory 330, and at least one sensor 340 configured for measuring a plurality of physical parameter related to a drill bit state, which may include drill bit condition, drilling operation conditions, and environmental conditions proximate the drill bit. In the exemplary embodiment of FIG. 7, the sensors 340 may include a plurality of accelerometers 340A, a plurality of magnetometers 340M, and at least one temperature sensor 340T.

The plurality of accelerometers 340A may include three accelerometers 340A configured in a Cartesian coordinate arrangement. Similarly, the plurality of magnetometers 340M may include three magnetometers 340M configured in a Cartesian coordinate arrangement. While any coordinate system may be defined within the scope of the present invention, an exemplary Cartesian coordinate system, shown in FIG. 5, defines a z-axis along the longitudinal axis about which the drill bit rotates, an x-axis perpendicular to the z-axis, and a y-axis perpendicular to both the z-axis and the x-axis, to form the three orthogonal axes of a typical Cartesian coordinate system. Because the data analysis module 300 may be used while the drill bit is rotating and with the drill bit in other than vertical orientations, the coordinate system may be considered a rotating Cartesian coordinate system with a varying orientation relative to the fixed surface location of the drilling rig.

The accelerometers 340A of the FIG. 7 embodiment, when enabled and sampled, provide a measure of acceleration, and thus vibration, of the drill bit along at least one of the three orthogonal axes. The data analysis module 300 may include additional accelerometers 340A to provide a redundant system, wherein various accelerometers 340A may be selected, or deselected, in response to fault diagnostics performed by the processor 320.

The magnetometers 340M of the FIG. 7 embodiment, when enabled and sampled, provide a measure of the orientation of the drill bit along at least one of the three orthogonal axes relative to the earth's magnetic field. The data analysis module 300 may include additional magnetometers 340M to provide a redundant system, wherein various magnetometers 340M may be selected, or deselected, in response to fault diagnostics performed by the processor 320.

The temperature sensor 340T may be used to gather data relating to the temperature of the drill bit, and the temperature near the accelerometers 340A, magnetometers 340M, and other sensors 340. Temperature data may be useful for calibrating the accelerometers 340A and magnetometers 340M to be more accurate at a variety of temperatures.

Other optional sensors 340 may be included as part of the data analysis module 300. Some exemplary sensors that may be useful in the present invention are strain sensors at various locations of the drill bit, temperature sensors at various locations of the drill bit, mud (drilling fluid) pressure sensors to measure mud pressure internal to the drill bit, and borehole pressure sensors to measure hydrostatic pressure external to the drill bit. These optional sensors 340 may include sensors 340 that are integrated with and configured as part of the data analysis module 300. These sensors 340 may also include optional remote sensors 340 placed in other areas of the drill bit, or above the drill bit in the bottom hole assembly 10. The optional sensors 340 may communicate using a direct-wired connection, or through an optional sensor receiver 360. The sensor receiver 360 is configured to enable wireless remote sensor communication across limited distances in a drilling environment as are known by those of ordinary skill in the art.

One or more of these optional sensors may be used as an initiation sensor 370. The initiation sensor 370 may be configured for detecting at least one initiation parameter, such as, for example, turbidity of the mud, and generating a power enable signal 372 responsive to the at least one initiation parameter. A power gating module 374 coupled between the power supply 310, and the data analysis module 300 may be used to control the application of power to the data analysis module 300 when the power enable signal 372 is asserted. The initiation sensor 370 may have its own independent power source, such as a small battery, for powering the initiation sensor 370 during times when the data analysis module 300 is not powered. As with the other optional sensors 340, some exemplary parameter sensors that may be used for enabling power to the data analysis module 300 are sensors configured to sample; strain at various locations of the drill bit, temperature at various locations of the drill bit, vibration, acceleration, centripetal acceleration, fluid pressure internal to the drill bit, fluid pressure external to the drill bit, fluid flow in the drill bit, fluid impedance, and fluid turbidity. In addition, at least some of these sensors may be configured to generate any required power for operation such that the independent power source is self-generated in the sensor. By way of example, and not limitation, a vibration sensor may generate sufficient power to sense the vibration and transmit the power enable signal 372 simply from the mechanical vibration.

The memory 330 may be used for storing sensor data, signal processing results, long-term data storage, and computer instructions for execution by the processor 320. Portions of the memory 330 may be located external to the processor 320 and portions may be located within the processor 320. The memory 330 may be Dynamic Random Access Memory (DRAM), Static Random Access Memory (SRAM), Read Only Memory (ROM), Nonvolatile Random Access Memory (NVRAM), such as Flash memory, Electrically Erasable Programmable ROM (EEPROM), or combinations thereof. In the FIG. 6 exemplary embodiment, the memory 330 is a combination of SRAM in the processor (not shown), Flash memory 330 in the processor 320, and external Flash memory 330. Flash memory may be desirable for low power operation and ability to retain information when no power is applied to the memory 330.

In one embodiment, the data analysis module 300 uses battery power as the operational power supply 310. Battery power enables operation without consideration of connection to another power source while in a drilling environment. However, with battery power, power conservation may become a significant consideration in the present invention. As a result, a low power processor 320 and low power memory 330 may enable longer battery life. Similarly, other power conservation techniques may be significant in the present invention.

Additionally, one or more power controllers 316 may be used for gating the application of power to the memory 330, the accelerometers 340A, the magnetometers 340M, and other components of the data analysis module 300. Using these power controllers 316, software running on the processor 320 may manage a power control bus 326 including control signals for individually enabling a voltage signal 314 to each component connected to the power control bus 326. While the voltage signal 314 is shown in FIG. 7 as a single signal, it will be understood by those of ordinary skill in the art that different components may require different voltages. Thus, the voltage signal 314 may be a bus including the voltages necessary for powering the different components.

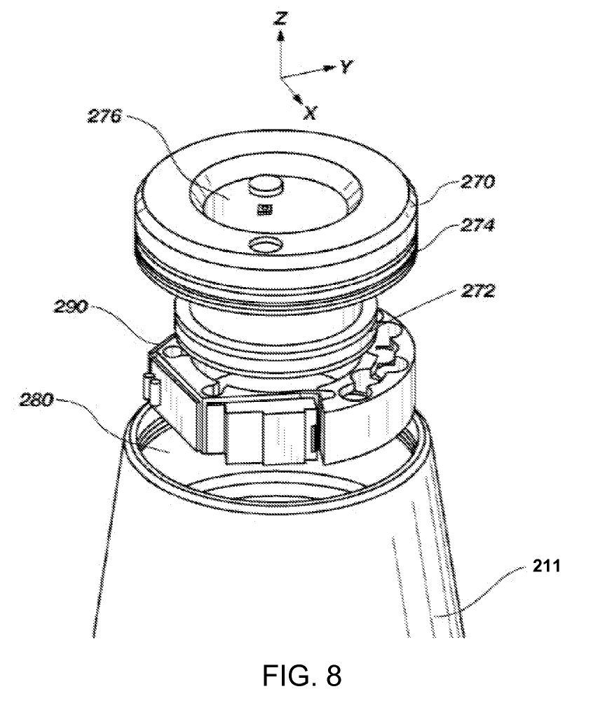

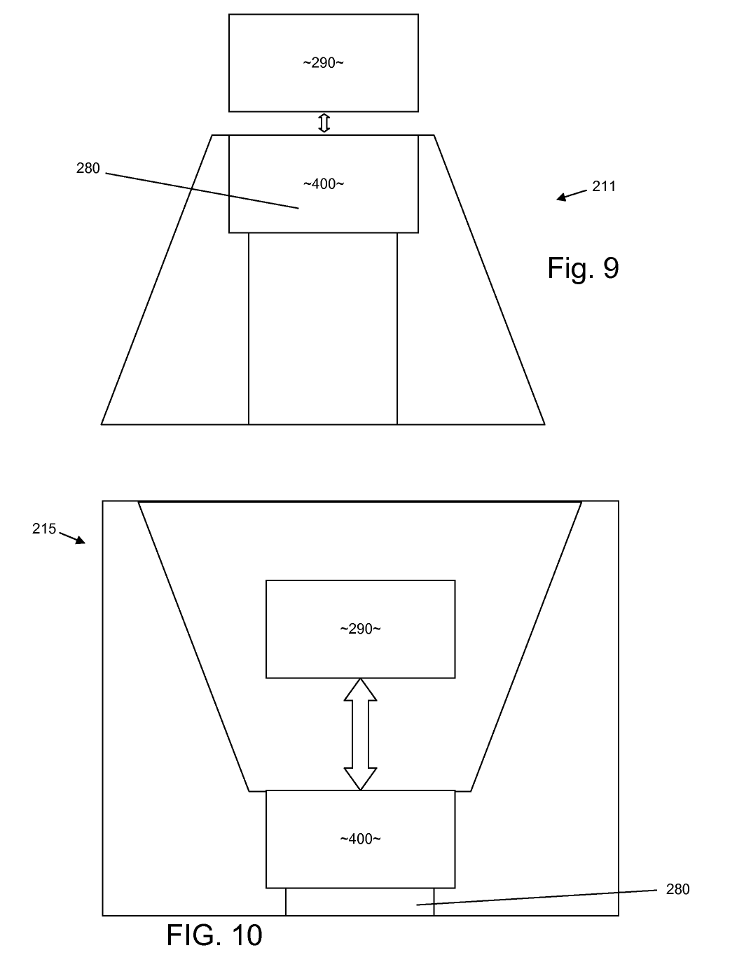

In addition to being associated with a lower drill bit, such as the pilot bit 30, the electronics module 290 may be associated with an upper reamer tool 100, as shown in FIG. 8. More specifically, the electronics module 290 may be inserted in the pin connection 211 and/or the box connection 215 of the joints 18,22 of the reamer tool 100. For example, as shown in FIG. 9 and FIG. 10, the electronics module 290 may be inserted in a pocket 400 of the pin connection 211 and/or the box connection 215 of the reamer tool 100. This is preferably done as the bottomhole assembly 10 is being assembled. Because the modules 290 are placed within pockets 400 of the pin and/or box connections 211,215, the bottomhole assembly 10 may remain substantially the same length as it would be without the modules 290.

As the bottomhole assembly 10 opens up the borehole, first with the pilot bit 30 and then expanding the bore hole with the reamer tool 100, the modules 290 record and store data, such as the vibration experienced by the reamer tool 100. Then, once the borehole is complete, the bottomhole assembly 10 is tripped, or extracted, from the borehole and disassembled, with the modules 290 removed therefrom. The data stored in the module 290 is then retrieved, either at the job site or remotely.

The data may be used to characterize the downhole environment as well as the performance of and forces experienced by the reamer tool 100, along with other components of the bottomhole assembly 10. The data can be used to optimize the design of the reamer tool 100 and/or other components of the bottomhole assembly 10. For example, two reamer tools may be compared under identical conditions, with lower vibration suggesting a better design for the reamer tool 100 under those conditions. In other cases, a single reamer design may be modified and/or improved and again subjected to the same conditions in order to evaluate the effectiveness of the modification. In any case, this may be an iterative process where multiple designs are subjected to identical or similar conditions.

Alternatively, or additionally, the data may be used to educate the drilling crew on proper techniques. For example, the data may be used to show the crew how to better utilize a particular style or design of the reamer tool 100 and/or other components of the bottomhole assembly 10.

In any case, in some embodiments, the modules 290 are placed in the pockets 400 of the reamer tool 100. The modules 290 preferably remain in the pockets 400 of the reamer tool 100, while the reamer tool 100 is utilized to ream the borehole. There, the module 290 record and/or otherwise store data related to, among other things, the vibration experienced by the reamer tool 100. Because one of the goals of the present invention is to optimize the design of the reamer tool 100, the modules 290 need not transmit the data to the surface while in the bottomhole assembly 10. Rather, once the borehole is complete, or whenever desired, the bottomhole assembly 10 is tripped to the surface, where the modules 290 may be removed and the data retrieved therefrom. The data may then be used to compare different designs of the reamer tool 100 and/or otherwise used to optimize the design of the reamer tool 100 and/or other components of the bottomhole assembly 10.

Other and further embodiments utilizing one or more aspects of the inventions described above can be devised without departing from the spirit of our invention. For example, rather than fitting within the pockets 400 of the pin and/or box connections 211,215, the modules 290 may be incorporated into the reamer tool 110 itself in a different manner, or may be attached to the reamer tool 110, or bottomhole assembly 10, in a different manner. Alternatively, the modules 290 may be incorporated other components of the bottomhole assembly 10, such as a sub 109 directly above and/or below the reamer tool 100. Additionally, rather than the pockets 400 being formed within the pin and/or box connections 211,215, the pockets 400 may be formed in a side of the reamer tool 100, sub 109, or other components of the bottomhole assembly 10. Further, the various methods and embodiments of the present invention can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of my/our invention, but rather, in conformity with the patent laws, we intend to fully protect all such modifications and improvements that come within the scope or range of equivalent of the following claims.

What is claimed is:

1. A method of optimizing the design of a reamer tool, the method comprising the steps of:
placing an electronic module in a component of a bottomhole assembly, the component being immediately adjacent to the reamer tool;
reaming a borehole with the reamer tool, with the module recording data throughout the reaming operation, storing the data for later retrieval, and being contained within the bottomhole assembly;
tripping the bottomhole assembly from the reamed borehole; and
retrieving the data once the bottomhole assembly has been tripped from the borehole.

2. The method as set forth in claim 1, wherein the module records vibration along three axis.

3. The method as set forth in claim 1, wherein the module is placed in a component immediately above the reamer tool and a second module is placed in a component immediately below the reamer tool.

4. The method as set forth in claim 1, wherein the module is placed in a pocket of a pin connector of the component.

5. The method as set forth in claim 1, wherein the module is placed in a pocket of a box connector of the component.

6. The method as set forth in claim 1, wherein the module is placed in a pocket in a side of the component.

7. The method as set forth in claim 1, wherein the module is placed in a pocket of a pin connector of the reamer tool and a second module is placed in a pocket of a box connector of the reamer tool.

8. The method as set forth in claim 1, further including the steps of assembling the bottomhole assembly with a pilot drill bit below the reamer tool.

9. A method of optimizing the design of a reamer tool, the method comprising the steps of:
placing an electronic module in a joint of a bottomhole assembly, the joint being immediately adjacent to the reamer tool;
reaming a borehole with the reamer tool, with the module recording data throughout the reaming operation, storing the data for later retrieval, and being contained within the bottomhole assembly;
tripping the bottomhole assembly from the reamed borehole; and
retrieving the data once the bottomhole assembly has been tripped from the borehole.

10. The method as set forth in claim 9, wherein the module records vibration along three axis.

11. The method as set forth in claim 9, wherein the module is placed in a joint immediately above the reamer tool and a second module is placed in a joint immediately below the reamer tool.

12. The method as set forth in claim 9, wherein the module is placed in a pocket of a pin connector of the joint.

13. The method as set forth in claim 9, wherein the module is placed in a pocket of a box connector of the joint.

14. The method as set forth in claim 9, wherein the module is placed in a pocket of a pin connector of the reamer tool and a second module is placed in a pocket of a box connector of the reamer tool.

15. The method as set forth in claim 9, further including the steps of assembling the bottomhole assembly with a pilot drill bit below the reamer tool.

16. A method of optimizing the design of a reamer tool, the method comprising the steps of:
placing an electronic module in a joint of the reamer tool;
reaming a borehole with the reamer tool, with the module recording data throughout the reaming operation, storing the data for later retrieval, and being contained within the bottomhole assembly;
tripping the bottomhole assembly from the reamed borehole; and
removing the module from the bottomhole assembly for retrieval of the data to be used to optimize the design of the reamer tool.

17. The method as set forth in claim 16, wherein the module records vibration along three axis.

18. The method as set forth in claim 16, wherein the module is placed in an upper joint of the reamer tool and a second module is placed in a lower joint of the reamer tool.

19. The method as set forth in claim 16, wherein the module is placed in a pocket of a pin connector of the joint.

20. The method as set forth in claim 16, wherein the module is placed in a pocket of a box connector of the joint.

21. The method as set forth in claim 16, wherein the module is placed in a pocket of a pin connector of the reamer tool and a second module is placed in a pocket of a box connector of the reamer tool.

22. The method as set forth in claim 16, further including the steps of assembling the bottomhole assembly with a pilot drill bit below the reamer tool.

23. A method of optimizing the design of a reamer tool, the method comprising the steps of:
placing a first electronic module in a first pocket of a lower joint of the reamer tool;
placing a second electronic module in a second pocket of an upper joint of the reamer tool;
reaming a borehole with the reamer tool, with the modules recording data throughout the reaming operation and storing the data for later retrieval;
tripping the bottomhole assembly from the reamed borehole;
removing the modules from the bottomhole assembly; and
retrieving the data from the modules to optimize the design of the reamer tool.

24. The method as set forth in claim 23, wherein the modules both record vibration along three axis.

25. The method as set forth in claim 23, further including the steps of assembling the bottomhole assembly with a pilot drill bit below the reamer tool.

26. A bottomhole assembly comprising:
a drill bit;
a reamer tool above the drill bit;
a first vibration recording electronic module in a pocket of a pin connector of the reamer tool; and
a second vibration electronic module in a pocket of a box connector of the reamer tool.

27. The bottomhole assembly as set forth in claim 26, wherein the modules record vibration data along three axis for retrieval after the bottomhole assembly has been removed from a borehole.

28. The bottomhole assembly as set forth in claim 26, wherein the bottomhole assembly is substantially the same length as it would be without the modules.

29. The bottomhole assembly as set forth in claim 26, wherein modules do not transmit the data to the surface while in the bottomhole assembly.
